(19) United States
(12) Patent Application Publication
(10) Pub. No.: US 2010/0306223 A1
(43) Pub. Date: Dec. 2, 2010

(54) Rankings in Search Results with User Corrections

(75) Inventors: John J. Lee, Brooklyn, NY (US); Andrew William Hogue, Ho-Ho-Kus, NJ (US); Dan N. Quine, New York, NY (US); Andriy Bihun, Pine Bush, NY (US); Daniel Loreto, New Rochelle, NY (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/476,110

(22) Filed: Jun. 1, 2009

(51) Int. Cl. G06F 17/30

(52) U.S. Cl. 707/759; 707/769

(57) ABSTRACT

Methods, systems, and apparatus, including computer programs encoded on a computer storage medium, for improving search with user corrections. In one aspect, a methods performed by a data processing apparatus include the actions of receiving a value result set, accessing historical records of user corrections stored at one or more data storage devices, the historical records describing user corrections of the characterization of instance attributes by values, determining that the historical records of user corrections describe a first user correction involving a first value in the value result set, and changing a confidence parameter embodying a confidence that the first value correctly characterizes the attribute of the instance. The value result set comprises a collection of one or more values. The values are candidates for characterizing an attribute of an instance. The first value is involved in the correction as either a corrected value or an uncorrected value.

### BACKGROUND

This specification relates to improving the rankings in search results with user corrections.

Search is generally an automated process in which a user enters a search query and receives responsive results in a result set. The results identify content that is relevant to the search query, e.g., in a machine-readable collection of digital data stored on data storage device.

An electronic document is a collection of machine-readable digital data. Electronic documents are generally individual files and are formatted in accordance with a defined format (e.g., PDF, TIFF, HTML, XML, MS Word, PCL, PostScript, or the like).

### SUMMARY

This specification describes technologies relating to improving search with user corrections.

In general, one innovative aspect of the subject matter described in this specification can be embodied in methods performed by data processing apparatus that include the actions of receiving a value result set, the value result set comprising a collection of one or more values, the values being candidates for characterizing an attribute of an instance, accessing historical records of user corrections stored at one or more data storage devices, the historical records describing user corrections of the characterization of instance attributes by values, determining that the historical records of user corrections describe a first user correction involving a value in the value result set, wherein the value is involved in the correction as either a corrected value or an uncorrected value; and changing a confidence parameter embodying a confidence that the involved value correctly characterizes the attribute of the instance.

Other embodiments of this aspect include corresponding systems, apparatus, and computer programs, configured to perform the actions of the methods, encoded on computer storage devices.

These and other embodiments can each optionally include one or more of the following features. The method can include ranking the values in the value result set to reflect the changed confidence parameter and visually displaying at least a portion of the value result set on a display screen. Outputting at least the portion of the value result set can include presenting a structured presentation to a user. The structured presentation can be populated with a first value included in the value result set. The first value is the value in the value result set that is most likely to correctly characterize the instance attribute. Visually displaying at least a portion of the value result set can include displaying a candidate window that includes candidate values for characterizing an instance attribute. Changing the confidence parameter can include generating a delta value suitable for application to a scaled confidence rating. The scaled confidence rating can embody the confidence that the involved value correctly characterizes the attribute of the instance. Generating the delta value can include weighting a category of a user correction of the involved value or categorizing the user correction.

Another innovative aspect of the subject matter described in this specification can be embodied in computer storage medium encoded with a computer program. The program can include instructions that when executed by data processing apparatus cause the data processing apparatus to perform operations. The operations can include receiving a description of a user correction involving a value characterizing an instance attribute, wherein the value is involved in the correction as either a corrected value or an uncorrected value, changing a confidence parameter reflecting the likelihood that the value correctly characterizes the instance attribute, and ranking a collection of candidate values that includes the value according to respective confidence parameters, including the changed a confidence parameter.

Other embodiments of this aspect include corresponding systems, apparatus, and methods, configured to perform the operations performed by the data processing apparatus.

These and other embodiments can each optionally include one or more of the following features.

The operations can include transmitting a description of the ranked collection of candidate values over a data communication network in response to receipt of a search query, the response to which includes an attribute value for an instance.

Receiving the description of the user correction can include receiving a description of whether that the user confirmed the correction with a source, receiving a description that the user did not change an uncorrected value after reviewing an electronic document, and receiving a description of the uncorrected value prior to the user correction and the corrected value after the user correction. Changing the confidence parameter can include categorizing the user correction and weighting the impact of the user correction on the confidence parameter according to the categorization of the user correction.

Weighting the impact of the user correction can include weighting user corrections made after confirmation from a source more heavily than user corrections made without confirmation from a source or weighting more recent user corrections more heavily than earlier user corrections. Changing the confidence parameter can include changing the confidence parameter reflecting the likelihood that an corrected value correctly characterizes the instance attribute.

Another innovative aspect of the subject matter described in this specification can be embodied in systems that include a client, a correction tracker operable to interact with the client to track the user input correcting the characterizations of the instance attributes and to store descriptions of the user input in records of the user correction history, one or more data storage devices storing the records of the user correction history, and a search engine operable to interact with the one or more data storage devices to access the records of the user correction history and to change a confidence that a first value correctly characterizes a first instance attribute in response to identifying a record describing a user correction correcting the characterization of the first instance attribute. The client includes an input device, a display screen, and a digital data processing device operable to display, on the display screen, characterizations of instance attributes by values and to receive, over the input device, user input correcting characterizations of instance attributes.

Other embodiments of this aspect include corresponding methods, apparatus, and computer programs, configured to perform the actions of the system elements, encoded on computer storage devices.

These and other embodiments can each optionally include one or more of the following features. The display screen can display a structured presentation under the direction of the digital data processing device, the structured presentation can associate instance attributes with values. The structured presentation can include interactive elements selectable by a user to identify an instance attribute whose characterization by a value is to be corrected. The interactive elements can include cells of the structured presentation. The structured presentation can be a deck of cards. The display screen can display a candidate window under the direction of the digital data processing device. The candidate window can present candidate corrected values for replacing an uncorrected value characterizing an instance attribute.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic representation of a system in which a historical record of user corrections is used to improve search for a current user.

FIG. 2 is a schematic representation of the supplementation of user correction history in the system of FIG. 1

FIGS. 3-5 are examples of structured presentations that characterize attributes of instances with values.

FIGS. 6 and 7 are flow charts of processes for improving search with user corrections.

FIGS. 8-11 are schematic representations of structured presentations in which user corrections of values of instance attributes can be received.

FIG. 12 is a flow chart of a process for improving search with user corrections.

FIG. 13 is a schematic representation of a user correction log.

FIG. 14 is a flow chart of a process for improving search with user corrections.

FIG. 15 is a schematic representation of an aggregated feedback data collection.

FIG. 16 is a schematic representation of a weighting parameter data collection.

FIG. 17 is a flow chart of a process for improving search with user corrections.

FIG. 18 is a schematic representation of a weighting parameter data collection.

Like reference numbers and designations in the various drawings indicate like elements.

### DETAILED DESCRIPTION

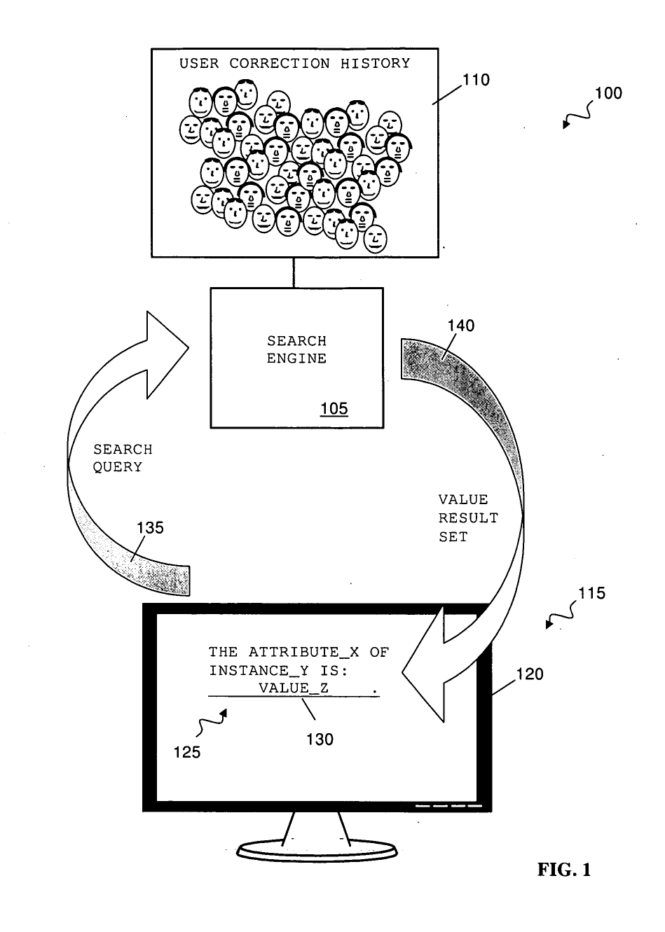

FIG. 1 is a schematic representation of a system 100 in which a historical record of user corrections is used to improve search for a current user. A user correction is an alteration of the characterization of an instance attribute by a value. Instances are individually identifiable entities. An attribute is a property, feature, or characteristic of an instance. For example, Tom, Dick, and Harry are instances of individuals. Each such individual has attributes such as a name, a height, a weight, and the like. As another example, city instances each have a geographic location, a mayor, and a population. As yet another example, a product instance can have a model name, a maker, and a year. The attributes of an instance can be characterized by values. The value of a particular attribute of a particular instance characterizes that particular instance. For example, the name of an individual can have the value “Tom,” the population of a city can have the value “4 million,” and the model name of a product can have the value “Wrangler.”

A user correction can also be an attempt to alter the characterization of an instance attribute by a value. User corrections are made by human users. User corrections are generally designed to correct or improve a value from the perspective of the user making the correction. A user correction can alter a value, e.g., by deleting the value, by editing the value, by refining the value, by substituting a corrected value for the uncorrected value, or by combinations of these and other alterations. An attempt to alter the characterization of an instance attribute can include a trackable user confirmation of the value with an electronic document, e.g., one available on the Internet. A record of a user correction can thus include one or more of a corrected value, an uncorrected value, and a notation of whether a confirmation was made. A record that includes multiple user corrections of one or more values can reflect the collective wisdom and work of a number of human users. The present inventors have recognized that such a record can be used to improve the usefulness of a search system for subsequent users.

System 100 includes a search engine 105, a user correction history 110, and a client 115. A current user can interact with client 115 to enter a search query, the response to which includes an attribute value for an instance. For example, the search query can inquire about the value of an attribute of an instance. Search engine 105 can respond to the search query by searching, e.g., electronic documents of a document collection such as the Internet, a store of information characterizing electronic documents, or a structured database organized and viewed through a database management system (DBMS). Search engine 105 can operate with an internal or external module to rank the results in a result set, e.g., according to the relevancy of the results to a search query. Search engine 105 can be implemented on one or more computers deployed at one or more geographical locations that are programmed with one or more sets of machine-readable instructions for searching in response to requests originating from multiple client devices.

In certain circumstances, search engine 105 can conduct a search and return a result set of one or more values responsive to the search query. As described further below, the content of the result set, the arrangement of results in the result set, or both can reflect corrections that have previously been made by users and recorded in user correction history 110.

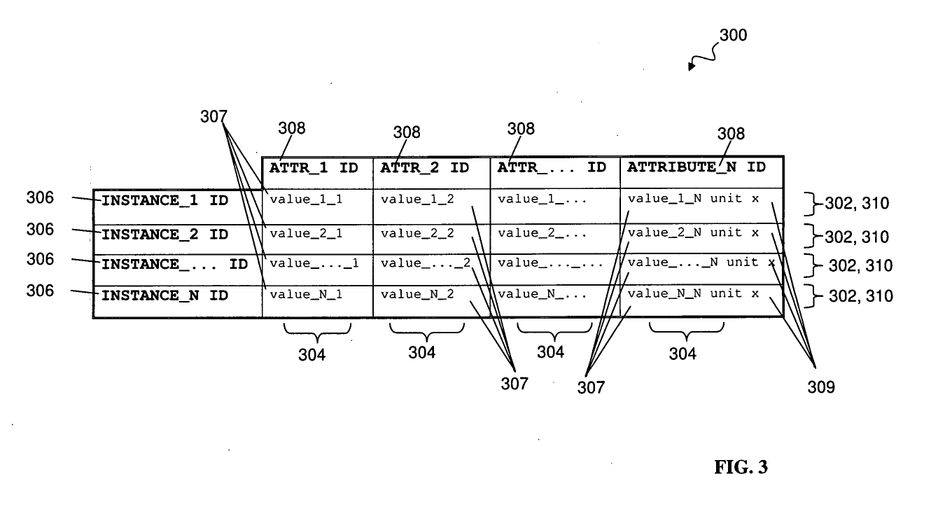

User correction history 110 stores information characterizing corrections that have previously been made by users. In some implementations, the corrections can be received from users who interact with a client in the context of a search. For example, as described further below, a user can interact with a structured presentation displayed at client 115, such as the structured presentations shown in FIGS. 3-5.

User correction history 110 can be stored on one or more data storage devices deployed at one or more geographical locations. The information in user correction history 110 is accessible either directly by search engine 105 or by one or more intermediate modules that can provide information characterizing the information content of user correction history 110 to search engine 105.

Client 115 is a device for interacting with a user and can be implemented on a computer programmed with machine-readable instructions. Client 115 can include one or more input/output devices, such as a display screen 120 for displaying information to the current user. For example, client 115 can display a presentation 125 on display screen 120.

Presentation 125 indicates that an attribute of an instance is characterized by a value 130 (e.g., “THE ATTRIBUTE_X OF INSTANCE_Y IS: VALUE_Z.”). Other presentations indicating that an attribute of an instance is characterized by a value 130, namely, structured presentations, are described in further detail below.

In general, a presentation indicating that an attribute of an instance is characterized by a value will be displayed during a search session. For example, a user who is currently interacting with client 115 can enter a search query using an input device such as a mouse or a keyboard. The response to the search query can include an attribute value for an instance. In some implementations, the search query can identify both an instance and an attribute of the instance that is to be characterized. For example, the search query can be an instance:attribute pair (e.g., “France:capital” or “mayor:Birmingham”). As another example, the search query can be formed so that identifiers of the instance and the attribute are found in a linguistic pattern indicating that a value characterizing the attribute of the instance is desired. Examples of such patterns include “what is the <attribute> of <instance>,” “who is <instance>'s <attribute>,” and the like.

As another example, a user can enter a search query by interacting with or referring to a structured presentation displayed on display screen 120. For example, as described further below, a user can click on a cell in a structured presentation or manually formulate a search query that refers to cells in a structured presentation as attribute and instance (e.g., “CELL_{—}1:CELL_{—}2”).

In some implementations, a search query need not identify both an instance and an attribute of the instance that is to be characterized. Rather, a search query can merely identify either an attribute or an instance, e.g., in a context that indicates that one or more attributes of one or more instances are to be characterized. For example, a query “mayors” can be taken as an inquiry requesting that values of the attribute “mayor” of city instances be identified. As another example, a query “richest women in the world” can be taken as an inquiry requesting that requesting that values of the attribute “name” of “richest women in the world” instances to be identified.

In response to receipt of the search query, client 115 transmits a representation of the search query, or the search query itself, to search engine 105 in a message 135. Message 135 can be transmitted over a data communications network. Search engine 105 can receive message 135 and use the content of message 135 to define parameters for searching. For example, the content of message 135 can be used to define terms used to search an indexed collection of electronic documents, to define a query in a DBMS query language, or combinations of these and other approaches.

Search engine 105 performs the search according to the parameters for searching defined by the content of message 135. The search can yield a result set of one or more values responsive to the search query described in message 135. The content of the result set, the arrangement of results in the result set, or both can reflect corrections that have previously been made by users and recorded in user correction history 110. For example, user corrections recorded in history 110 can be incorporated into a database or other body of data that is searched by search engine 105. The user corrections can thus themselves be the source of values included in the result set. As another example, user corrections recorded in history 110 can be used in ranking values in the result set.

The values in the value result set are candidates for characterizing one or more attributes of one or more instances and are responsive to the search query. The content and arrangement of values in the value result set can reflect one or more changes in the confidence that particular values correctly characterize an attribute of an instance. For example, when a user correction is a source of a value included in the result set, that value may go from having a low confidence and hence being excluded from the result set to having a confidence that is high enough to justify inclusion in the result set. As another example, the ranking of values in the result set can reflect the confidence in the individual values. In particular, a value that is more likely to correctly characterize an attribute of an instance will generally be ranked above a value that is less likely to correctly characterize an attribute of an instance.

Search engine 105 transmits a representation of the result set that reflects user corrections to client 115 in a message 140. Message 140 can be transmitted, e.g., over the same data communications network that transmitted message 135. Client 115 can receive message 140 and use the content of message 140 to display a presentation 125 on display screen 120. Presentation 125 characterizes an attribute of an instance with a value 130 which is found in the value result set that reflects user corrections. In some implementations, presentation 125 can use text to indicate that an attribute of an instance is characterized by a value 130, as shown. In some implementations, presentation 125 can use the arrangement of identifiers of an attribute and an instance to indicate that the identified attribute of the identified instance is characterized by a value 130. For example, presentation 125 can be a structured presentation that displays values and identifier of instance attributes in an organized, systematic arrangement so that the characterization of an instance attribute by a value is apparent to a user, as described further below. In some implementations, systems such as system 100 can be used to supplement user correction history 110.

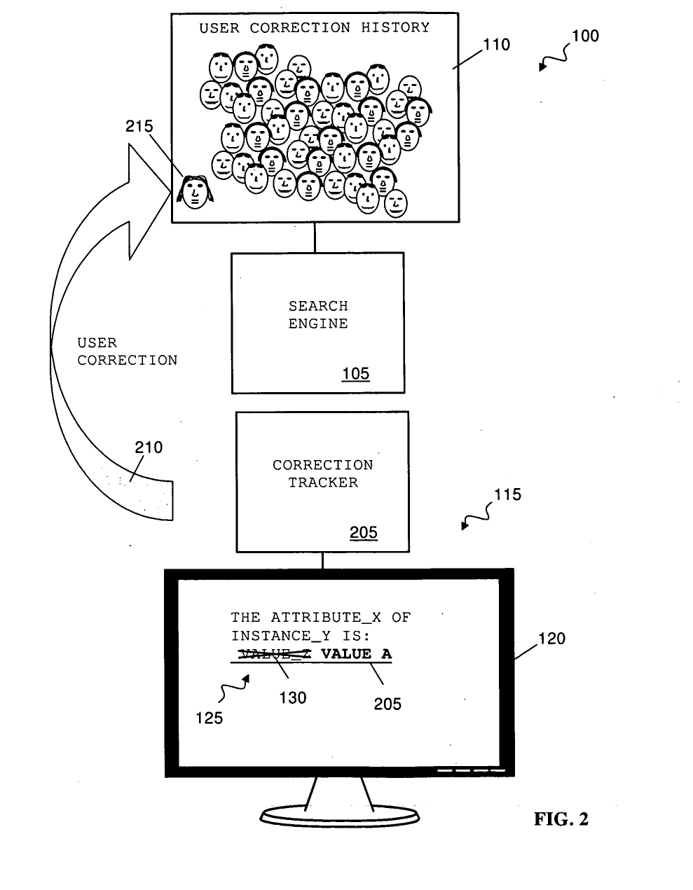

FIG. 2 is a schematic representation of the supplementation of user correction history 110 in system 100. As shown, a correction tracker 205 is coupled to client 115. Correction tracker 205 is a component for tracking corrections of characterizations of instance attributes made by a user at client 115. For example, correction tracker 205 can be implemented on one or more computers deployed at one or more geographical locations that are programmed with one or more sets of machine-readable instructions. Correction tracker 205 can be implemented using in client 115, for example, in a client side script, or it can be implemented search engine 105, or elements of correction tracker 205 can be implemented in both.

In the illustrated implementation, a user at client 115 has corrected presentation 125. In particular, the user has deleted an uncorrected value 130 and replaced it with a corrected value 205.

Correction tracker 205 can track the correction by recording a representation of the alteration(s) made by the user. Correction tracker 205 can also transmit data representing the user correction directly or indirectly in a message 210 to search engine 105 for storage in user correction history 110. Message 210 can be an XML document or other form of data package. The content of message 210 can be used to create a new record 215 of the user correction. New record 215 supplements the historical record of user corrections at user correction history 110.

FIGS. 3-5 are examples of structured presentations that associate attributes of instances with values. FIG. 3 is a schematic representation of an example table structured presentation 300. Table 300 is an organized, systematic arrangement of one or more identifiers of instances, as well as the values of particular attributes of those instances. In some implementations, structured presentations such as table 300 can also include identifiers of attributes, as well as identifiers of the units in which values are expressed.

The grouping, segmentation, and arrangement of information in table 300 can be selected to facilitate understanding of the information by a user. In this regard, table 300 includes a collection of rows 302. Each row 302 includes an instance identifier 306 and a collection of associated attribute values 307. The arrangement and positioning of attribute values 307 and instance identifiers 306 in rows 302 thus graphically represents the associations between them. For example, a user can discern the association between attribute values 307 and the instance identifier 306 that is found in the same row 302.

Table 300 also includes a collection of columns 304. Each column 304 includes an attribute identifier 308 and a collection of associated attribute values 307. The arrangement and positioning of attribute values 307 and attribute identifier 308 in columns 304 thus graphically represent the associations between them. For example, a user can discern the association between attribute values 307 and the attribute identifier 308 that is found in the same column 304 based on their alignment.

Each row 302 is a structured record 310 in that each row 302 associates a single instance identifier 306 with a collection of associated attribute values 307. Further, the arrangement and positioning used to denote these associations in one structured record 310 is reproduced in other structured records 310 (i.e., in other rows 302). Indeed, in many cases, all of the structured records 310 in a structured presentation 106 are restricted to having the same arrangement and positioning of information. For example, values 307 of the attribute “ATTR_{—}2” are restricted to appearing in the same column 304 in all rows 302. As another example, attribute identifiers 308 all bear the same spatial relationship to the values 307 appearing in the same column 304. Moreover, changes to the arrangement and positioning of information in one structured record 310 are generally propagated to other structured records 310 in the structured presentation 106. For example, if a new attribute value 307 that characterizes a new attribute (e.g., “ATTR_{—}2¾”) is added to one structured record 310, then a new column 304 is added to structured presentation 106 so that the values of attribute “ATTR_{—}2¾” of all instances can be added to structured presentation 106.

In some implementations, values 307 in table 300 can be presented in certain units of measure. Examples of units of measure include feet, yards, inches, miles, seconds, gallons, liters, degrees Celsius, and the like. In some instances, the units of measure in which values 307 are presented are indicated by unit identifiers 309. Unit identifiers 309 can appear, e.g., beside values 307 and/or beside relevant attribute identifiers 308. The association between unit identifiers 309 and the values 307 whose units of measure are indicated is indicated to a viewer by such positioning. In many cases, all of the values 307 associated with a single attribute (e.g., all of the values 307 in a single column 304) are restricted to being presented in the same unit of measure.

The values in a value result set (such as the value result set described in message 140 (FIG. 1)) can be used to populate table 300 or other structured presentation in a variety of different ways. For example, a structured presentation can be populated automatically (i.e., without human intervention) with a collection of values drawn from multiple search result sets that are each responsive to queries for instance attributes. For example, the individual values most likely to correctly characterize the instance attributes can be displayed in the structured presentation by default. A user can alter, or attempt to alter, those values by, e.g., interacting with or referring to the structured presentation. Other values in a value result set can be presented as candidates for replacing the value which the search engine has determined is most likely to correctly characterize the instance attributes.

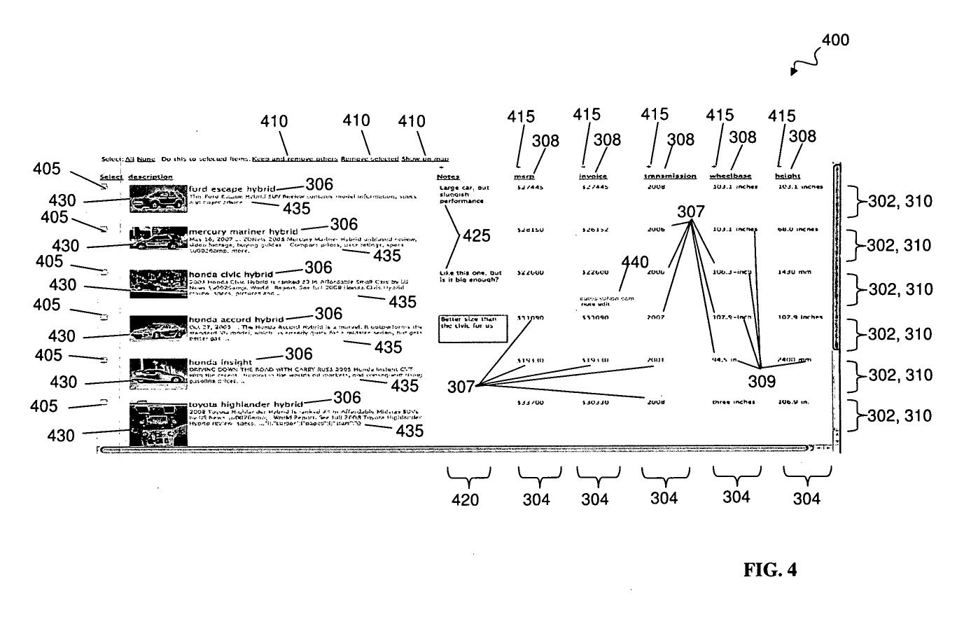

FIG. 4 is a schematic representation of another implementation of a structured presentation, namely, a structured presentation table 400. In addition to including attribute identifiers 308, instance identifiers 306, values 307, unit identifiers 309 organized into rows 302 and columns 304, table 400 also includes a number of interactive elements for interacting with a user. In particular, table 400 includes a collection of instance selection widgets 405, a collection of action triggers 410, a collection of column action trigger widgets 415, and a notes column 420.

Instance selection widgets 405 are user interface components that allow a user to select structured records 310 in table 400. For example, instance selection widgets 405 can be a collection of one or more clickable checkboxes that are associated with a particular structured record 310 by virtue of arrangement and positioning relative to that structured record 310. Instance selection widgets 405 are “clickable” in that a user can interact with widgets 405 using a mouse (e.g., hovering over the component and clicking a particular mouse button), a stylus (e.g., pressing a user interface component displayed on a touch screen with the stylus), a keyboard, or other input device to invoke the functionality provided by that component.

Action triggers 410 are user interface components that allow a user to trigger the performance of an action on one or more structured records 310 in table 400 selected using instance selection widgets 405. For example, action triggers 410 can be clickable text phrases, each of which can be used by a user to trigger an action described in the phrase. For example, a “keep and remove others” action trigger 410 triggers the removal of structured records 310 that are not selected using instance selection widgets 405 from the display of table 400. As another example, a “remove selected” action trigger 410 triggers the removal of structured records 310 that are selected using instance selection widgets 405 from the display of table 400. As yet another example, a “show on map” action trigger 410 triggers display of the position of structured records 310 that are selected using instance selection widgets 405 on a geographic map. For example, if a selected instance is a car, locations of car dealerships that sell the selected car can be displayed on a map. As another example, if the selected instances are vacation destinations, these destinations can be displayed on a map.

Column action trigger widgets 415 are user interface components that allow a user to apply an action to all of the cells within a single column 304. When a user interacts with the clickable ‘+’ sign, a further user interface component is displayed which offers to the user a set of possible actions to be performed. The actions in this set can include, e.g., removing the entire column 304 from the structured presentation 400 or searching to find values for all the cells in column 304 which are currently blank.

Notes column 420 is a user interface component that allows a user to associate information with an instance identifier 306. In particular, notes column 420 includes one or more notes 425 that are each associated with a structured record 310 by virtue of arrangement and positioning relative to that structured record 310. The information content of notes 425 is unrestricted in that, unlike columns 304, notes 425 are not required to be values of any particular attribute. Instead, the information in notes 425 can characterize unrelated aspects of the instance identified in structured record 310.

In some implementations, table 400 can include additional information other than values of any particular attribute. For example, table 400 can include a collection of images 430 that are associated with the instance identified in a structured record 310 by virtue of arrangement and positioning relative to that structured record 310. As another example, table 400 can include a collection of text snippets 435 extracted from electronic documents in collection 102. The sources of the snippets can be highly ranked results in searches conducted using instance identifiers 306 as a search string. Text snippets 435 are associated with the instance identified in a structured record 310 by virtue of arrangement and positioning relative to that structured record 310.

As another example, table 400 can include one or more hypertext links 440 to individual electronic documents in collection 102. For example, the linked documents can be highly ranked results in searches conducted using instance identifiers 306 as a search string. As another example, the linked documents can be source of a value 307 that was extracted to populate table 400. In some instances, interaction with hypertext link 440 can trigger navigation to the source electronic document based on information embedded in hypertext link 440 (e.g., a web site address).

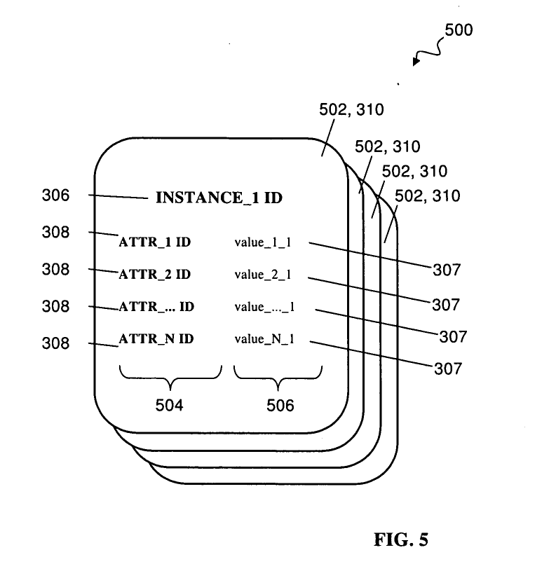

FIG. 5 is a schematic representation of another implementation of a structured presentation, namely, a card collection 500. Card collection 500 is an organized, systematic arrangement of one or more identifiers of instances, as well as the values of particular attributes of those instances. The attributes of an instance can be specified by values. Moreover, card collection 500 generally includes identifiers of attributes, as well as identifiers of the units in which values are expressed, where appropriate.

The grouping, segmentation, and arrangement of information in card collection 500 can be selected to facilitate an understanding of the information by a user. In this regard, card collection 500 includes a collection of cards 502. Each card 502 includes an instance identifier 306 and a collection of associated attribute values 307. The arrangement and positioning of attribute values 307 and instance identifiers 306 in cards 502 thus graphically represents the associations between them. For example, a user can discern the association between attribute values 307 and the instance identifier 306 that is found on the same card 502.

In the illustrated implementation, cards 502 in card collection 500 also include a collection of attribute identifiers 308. Attribute identifiers 308 are organized in a column 504 and attribute values 307 are organized in a column 506. Columns 504, 506 are positioned adjacent one another and aligned so that individual attribute identifiers 308 are positioned next to the attribute value 307 that characterizes that identified attribute. This positioning and arrangement allows a viewer to discern the association between attribute identifiers 308 and the attribute values 307 that characterize those attributes.

Each card 502 is a structured record 310 in that each card 502 associates a single instance identifier 306 with a collection of associated attribute values 307. Further, the arrangement and positioning used to denote these associations in one card 502 is reproduced in other cards 502. Indeed, in many cases, all of the cards 502 are restricted to having the same arrangement and positioning of information. For example, the value 307 that characterizes the attribute “ATTR_{—}1” is restricted to bearing the same spatial relationship to instance identifiers 306 in all cards 502. As another example, the order and positioning of attribute identifiers 308 in all of the cards 502 is the same. Moreover, changes to the arrangement and positioning of information in one card 502 are generally propagated to other cards 502 in card collection 500. For example, if a new attribute value 307 that characterizes a new attribute (e.g., “ATTR_{—}1¾”) is inserted between the attribute values “value_{—}1_{—}1” and “value_{—}2_{—}1” in one card 502, then the positioning of the corresponding attribute values 307 in other cards 502 is likewise changed.

In some implementations, cards 502 in card collection 500 can include other features. For example, cards 502 can include interactive elements for interacting with a user, such as instance selection widgets, action triggers, attribute selection widgets, a notes entry, and the like. As another example, cards 502 in card collection 500 can include additional information other than values of any particular attribute, such as images and/or text snippets that are associated with an identified instance. As another example, cards 502 in card collection 500 can include one or more hypertext links to individual electronic documents in collection 102. Such features can be associated with particular instances by virtue of appearing on a card 502 that includes an instance identifier 306 that identifies that instance.

During operation, a viewer can interact with the system presenting card collection 500 to change the display of one or more cards 502. For example, a viewer can trigger the side-by-side display of two or more of the cards 502 so that a comparison of the particular instances identified on those cards is facilitated. As another example, a viewer can trigger a reordering of card 502, an end to the display of a particular card 502, or the like. As another example, a viewer can trigger the selection, change, addition, and/or deletion of attributes and/or instances displayed in cards 502. As yet another example, a viewer can trigger a sorting of cards into multiple piles according to, e.g., the values of an attribute values 307 in the cards.

In some implementations, cards 502 will be displayed with two “sides.” For example, a first side can include a graphic representation of the instance identified by instance identifier 306, while a second side can include instance identifier 306 and values 307. This can be useful, for example, if the user is searching for a particular card in the collection of cards 500, allowing the user to identify the particular card with a cursory review of the graphical representations on the first side of the cards 502.

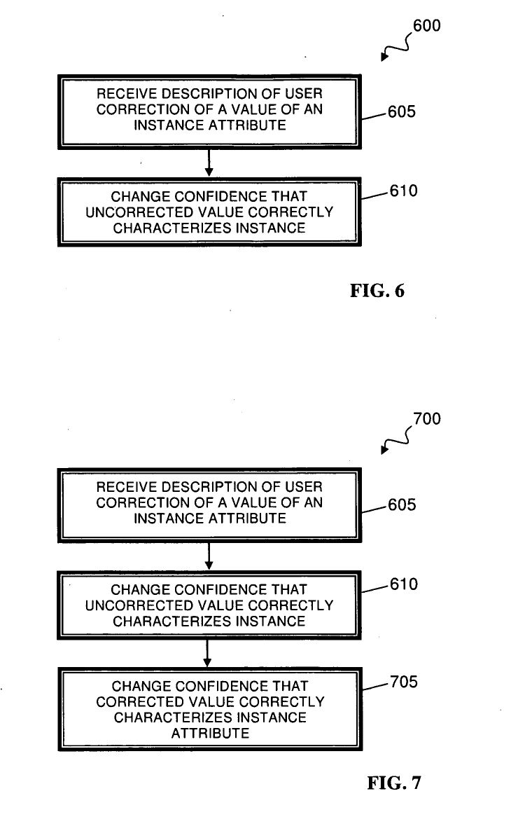

FIG. 6 is a flow chart of a process 600 for improving search with user corrections. Process 600 can be performed by one or more computers that perform digital data processing operations by executing one or more sets of machine-readable instructions. For example, process 600 can be performed by the search engine 105 in system 100 (FIG. 1). In some implementations, process 600 can be performed in response to the receipt of a trigger, such as a user request to use user corrections to improve search. Process 700 can be performed in isolation or in conjunction with other digital data processing operations.

The system performing process 600 can receive a description of a user correction of a value of an instance attribute (step 605). A user correction is an alteration or an attempted alteration of a value. A user correction may be submitted to prevent a mischaracterization of the attribute of the instance by a false value, to characterize the attribute of the instance correctly using an appropriate value, or to refine the characterization of the attribute of the instance. Example corrections of a value of an instance attribute can thus include, e.g., deleting a value, adding a new value, changing a value, or confirming the value with a source document. Example changes to a value include, e.g., correcting the spelling of the value, adding a time constraint to the value, increasing the accuracy of a value, and the like.

The system performing process 600 can also change a confidence value that indicates a degree of confidence that the uncorrected value correctly characterizes the attribute of the instance (step 610). An uncorrected value is the value prior to correction by the present user. For example, as described further below, an uncorrected value can be a value returned after an initial search of a document collection or a database. The initial search—and the uncorrected value itself—can reflect corrections by other users.

Confidence is a characterization of the likelihood that a value correctly characterizes an attribute of an instance. For example, a value with a high confidence is one that has been determined to be likely to correctly characterize the attribute of the instance. On the other hand, it has been determined to be unlikely that a value with a low confidence correctly characterizes the attribute of the instance.

The confidence that a value correctly characterizes an attribute of an instance can be embodied in a confidence score or other parameter. The system can change or create a confidence parameter in response to the received user correction of a value of an attribute, as described further below. In some implementation, the confidence parameter can be a scaled rating of the confidence in the value of the attribute. For example, the confidence parameter can be percent certainty (e.g., “90% certain”) that a value correctly characterizes the attribute of the instance. In other implementations, the confidence parameter can be an increment (i.e., a “delta”) that can be applied to a scaled rating of the confidence in the value of the attribute. For example, the confidence parameter can be an increase or decrease in the percent certainty (e.g., “2% more certain” or “3% less certain”) that the value correctly characterizes the attribute of the instance.

FIG. 7 is a flow chart of a process 700 for improving search with user corrections. Process 700 can be performed by one or more computers that perform digital data processing operations by executing one or more sets of machine-readable instructions. For example, process 700 can be performed by the search engine 105 in system 100 (FIG. 1). In some implementations, process 700 can be performed in response to the receipt of a trigger, such as a user request to use user corrections to improve search. Process 700 can be performed in isolation or in conjunction with other digital data processing operations.

The system performing process 700 can receive a description of a user correction of a value of an instance attribute (step 605) and change the confidence that the uncorrected value correctly characterizes the attribute of the instance (step 610).

The system performing process 700 can also change the confidence that the corrected value correctly characterizes the attribute of the instance (step 705). A corrected value is the value after correction by the present user. For example, as described further below, a corrected value can be a value selected from a list of candidate values, a changed version of the uncorrected value, or an entirely new value entered by the user. The change in confidence can be embodied in a confidence parameter, such as a scaled rating or a delta that can be applied to a scaled rating.

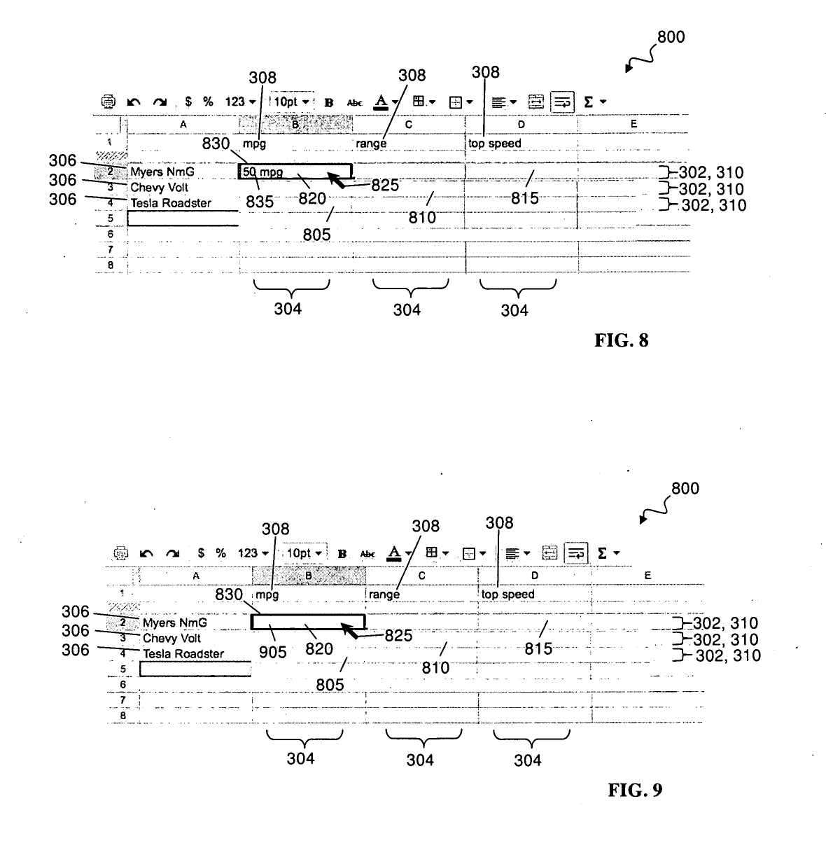

FIG. 8 is a schematic representation of a structured presentation in which a user correction of a value of an instance attribute can be received, namely, a structured presentation 800. Structured presentation 800 can be used to receive a user correction of a value of an instance attribute, e.g., at step 605 in methods 600, 700 (FIGS. 6, 7).

Structured presentation 800 can be any form of structured presentation, including any of the structured presentations described above. For example, structured presentation 800 can be a data table displayed in a spreadsheet framework, as shown. The data table of structured presentation 800 includes a collection of rows 302 and columns 304. Each row 302 includes a respective instance identifier 306 and each column 304 includes a respective attribute identifier 308. The arrangement and positioning of instance identifiers 306 and attribute identifiers 308 in rows 302 and columns 304 associates each cell of the spreadsheet framework in which structured presentation 800 is displayed with an instance and an attribute. For example, a cell 805 in structured presentation 800 is associated with the instance identified as “Tesla Roadster” and the attribute identified as “mpg.” A cell 810 in structured presentation 1000 is associated with the instance identified as “Chevy Volt” and the attribute identified as “range.” A cell 815 in structured presentation 800 is associated with the instance identified as “Myers NmG” and the attribute identified as “top speed.” A cell 1020 in structured presentation 800 is associated with the instance identified as “Myers NmG” and the attribute identified as “mpg.”

The associations between instance, attributes, and cells such as cells 805, 810, 815, 820 can be used to identify the attribute of the instance that is being corrected by a user. For example, receipt of user interaction selecting cell 820 can identify the attribute identified as “mpg” of the instance identified as “Myers NmG.” User interaction selecting a cell can include, e.g., receipt of input positioning a cursor 825 over the cell, the user clicking on the cell, or the like. In some implementations, the selection of a cell can be denoted by positioning a visual indicia such a perimetrical highlight 830 in or around the cell.

In the illustrated implementation, selected cell 820 includes an uncorrected value 835 (i.e., “50 mpg”) at the time of selection. For example, cell 820 in structured presentation 800 could have been populated with the results of a search performed, e.g., using an instance:attribute pair, in response to a user interacting with cell 820, or in response to a user 15 referring to cell 820. Value 835 is an uncorrected value in that value 835 is the value of the attribute identified as “mpg” of the instance identified as “Myers NmG” displayed by the system.

FIG. 9 is a schematic representation of structured presentation 800 after a user correction of value 835 has been received. As shown, value 835 has thus been deleted from cell 820. The user may have deleted value 835 from cell 820 to correct what the user saw as a mischaracterization of the attribute identified as “mpg” of the instance identified as “Myers NmG” by value 835.

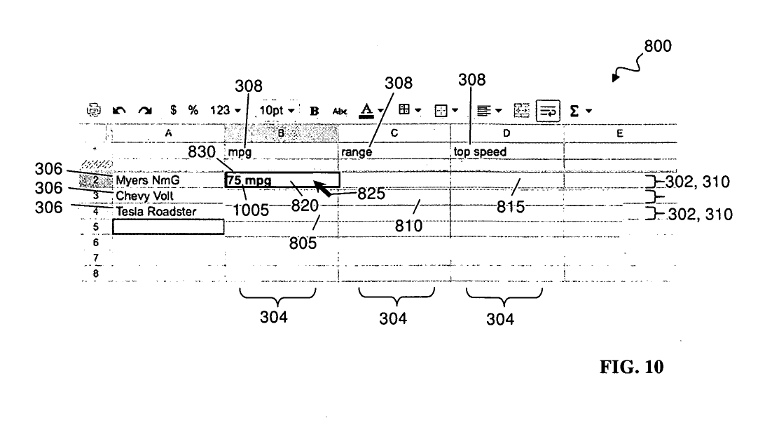

FIG. 10 is a schematic representation of structured presentation 800 after a corrected value 1005 has been received. As shown, the blank space left by deletion of value 835 from cell 820 has been filled with value 1005, which is provided by the user. Structured presentation 800 has thus been corrected to include value 1005 (i.e., “75 mpg”) in cell 820. The user may have made this deletion and replacement to correct what the user sees as a mischaracterization of the attribute identified as “mpg” of the instance identified as “Myers NmG” by value 835 and to correctly characterize the attribute identified as “mpg” of the instance identified as “Myers NmG” with value 1005.

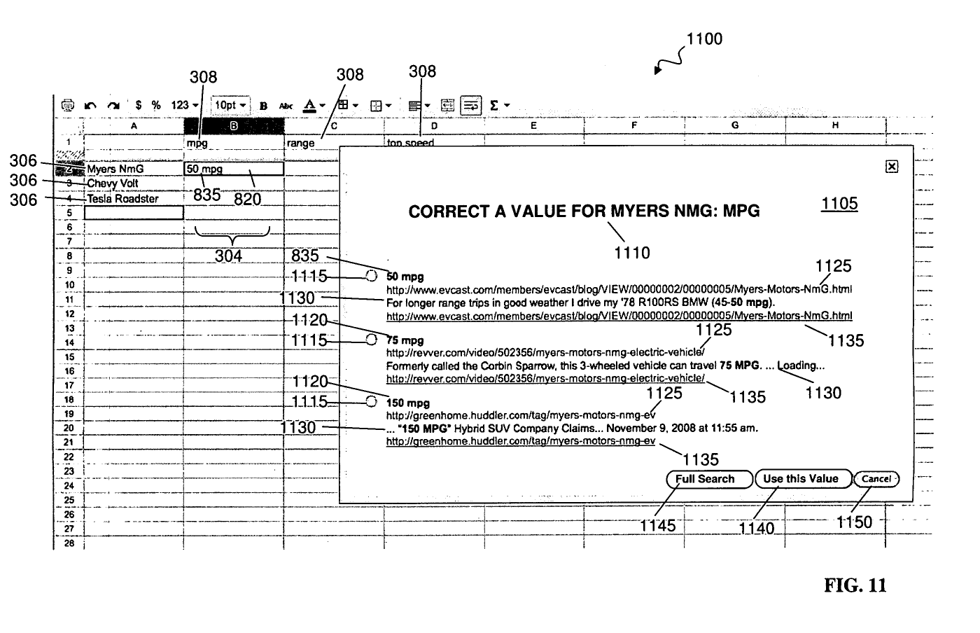

FIG. 11 is a schematic representation of a structured presentation in which a user correction of a value of an instance attribute can be received, namely, a structured presentation 1100. Structured presentation 1100 can be used to receive a user correction of a value of an instance attribute, e.g., at step 605 in methods 600, 700 (FIGS. 6, 7). In particular, user interaction selecting or referring to cell 820 can be used to trigger the presentation of a candidate window 1105. Candidate window 1105 presents candidate corrected values that are considered likely to be suitable for replacing an uncorrected value currently characterizing an instance attribute. In some implementations, the candidate values can be other values in a value result set, such as a value result set described in message 140 (FIG. 1). Thus, in some implementations, the nature and ranking of candidate corrected values can themselves reflect prior user corrections.

Candidate window 1105 includes a header 1110, a collection of selection widgets 1115, a collection of identifiers 1120 of corrected candidate values, a collection of source identifiers 1125, a collection of snippets 1130, and a collection of search interactive elements 1135, a selection trigger 1140, a full search trigger 1145, and a cancel trigger 1150.

Header 1110 can include text or other information that identifies the attribute of the instance which is characterized by a value which can be corrected. In the illustrated implementation, the attribute and instance (i.e., Myers NmG: mpg) that are characterized by the value 835 in cell 820 are identified.

Selection widgets 1115 are interactive display devices that allow a user to select a value that is to be used to characterize the attribute and the instance identified in header 1110. In the illustrated implementation, the user can select from among the uncorrected value 835 and two candidate corrected values identified by value identifiers 1120.

Value identifiers 1120 include text or other information that identifies candidate corrected values for characterizing the attribute and the instance identified in header 1110. The candidate corrected values identified by value identifiers 1120 can be drawn, e.g., from electronic documents in an electronic document collection such as the Internet.

Source identifiers 1125 include text or other information that identifies one or more electronic documents in which value 835 and the candidate corrected values identified by value identifiers 1625 appear. In some implementations, source identifiers 1125 can also include hyperlinks to one or more electronic documents in which the value 835 and candidate corrected values identified by value identifiers 1125 appear. A user can follow such a hyperlink to confirm the respective of uncorrected value 835 and the corrected values identified by value identifiers 1120 directly with one or more source documents.

Each snippet 1130 is text or other information that describes the context of value 835 and the candidate corrected values identified by value identifiers 1120 in an electronic document. Snippets 1130 can allow a user to confirm the respective of uncorrected value 835 and the candidate corrected values identified by value identifiers 1120 indirectly, i.e., from candidate window 1105 without linking to a source document.

Search interactive elements 1135 are hyperlinks that allow a user to navigate to an electronic document in which the respective of value 835 or values identified by value identifiers 1125 appears. A user can follow a search interactive element 1135 to confirm the respective of uncorrected value 835 and the candidate corrected values identified by value identifiers 1120 directly from the linked electronic document.

Selection trigger 1140 is an interactive element that allows a user to consent to the use of a value to characterize the attribute and the instance identified in header 1110. In particular, selection trigger 1140 allows the user to consent to the use of uncorrected value 835 or either of the candidate corrected values identified by value identifiers 1120. When a user consents to the use of either of the candidate corrected values, the selected value is substituted for value 835 in cell 820. The selected value is thus no longer a candidate corrected value but rather a corrected value.

Search trigger 1145 is an interactive element that triggers a search of an electronic document collection. Search trigger 1145 can allow a user to confirm an uncorrected value 835, as well as both of the corrected values identified by value identifiers 1120, directly from another source, such as an electronic document on the web. The search triggered by search trigger 1805 can be a “full search” in that it is conducted using a general purpose Internet search engine such as the GOOGLE™ search engine available at www.google.com. In some implementations, the search engine can be presented with a query that is automatically generated using the attribute of the instance identified in heading 1110. The confirmation of a value by the user using a search can be recorded.

Cancel trigger 1150 is an interactive element that allows a user to cancel a correction of the value characterizing the attribute of the instance identified in heading 1110. Cancel trigger 1150 can be used, e.g., when a user mistakenly identifies the wrong cell.

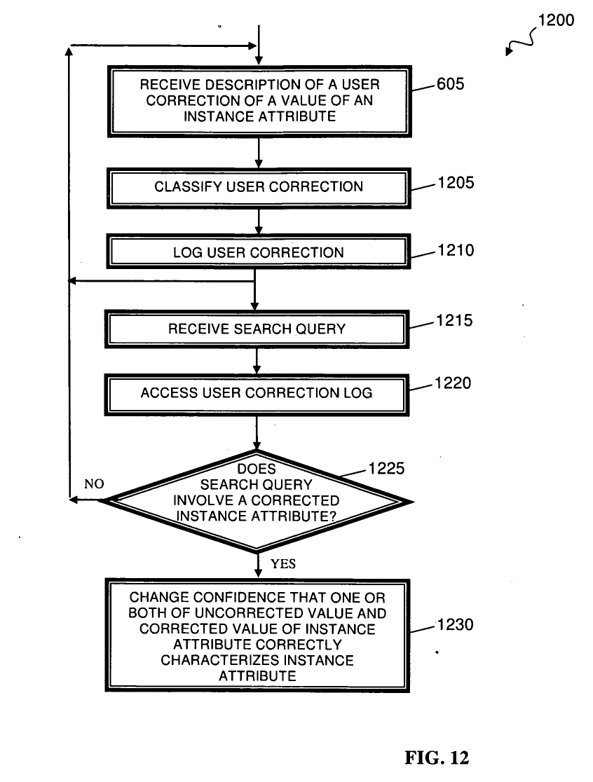

FIG. 12 is a flow chart of a process 1200 for improving search with user corrections. Process 1200 can be performed by one or more computers that perform digital data processing operations by executing one or more sets of machine-readable instructions. For example, process 1200 can be performed by the search engine 105 using a historical record of user corrections 110 in system 100 (FIGS. 1, 2). In some implementations, process 1200 can be performed in response to the receipt of a trigger, such as a user request to use user corrections to improve search. Process 1200 can be performed in isolation or in conjunction with other digital data processing operations. For example, process 1200 can be performed as either of processes 600, 700 (FIGS. 6, 7).

The system performing process 1200 can receive a description of a user correction of a value of an instance attribute (step 605). For example, the system performing process 1200 can receive a user correction made in interacting with displays such as structured presentations 800, 1100 (FIGS. 8-11).

The system performing process 1200 can also classify the user correction (step 1205). The user correction can be classified according to the activities performed by the user in correcting a value. For example, in some implementations, a user correction can be classified into one of the seven different classes shown in Table 1 below.

TABLE 1
CORRECTION CLASSES

| | |
|---|---|
| Class 1: | User selection of a candidate corrected value from a collection, |
| | without direct confirmation with a source. |
| Class 2: | User selection of a candidate corrected value from a collection, |
| | after user directly confirming with a source. |
| Class 3: | User replacement of an uncorrected value with a corrected value, |
| | without user directly confirming with a source. |
| Class 4: | User replacement of an uncorrected value with a corrected |
| | value, after user directly confirming with a source. |
| Class 5: | User did not change an uncorrected value after user directly |
| | confirming with a source (i.e., a failed attempted alteration). |
| Class 6: | User deletion of an uncorrected value without replacement by a |
| | corrected value, without user directly confirming with a source. |
| Class 7: | User deletion of an uncorrected value without replacement by a |
| | corrected value, after user directly confirming with a source. |

The activities used to classify a user correction (including any search for a confirmation) can be recorded during user interaction with displays such as structured presentations 800, 1100 (FIGS. 8-11), as described above.

The system performing process 1200 can log the user correction, e.g., by storing it in a digital data storage device (step 1210). The user correction can be logged as a collection of information that identifies the attribute of the instance that was corrected, the uncorrected value, and any corrected values. In general, the log of a user correction will also include an identification of the classification of the correction.

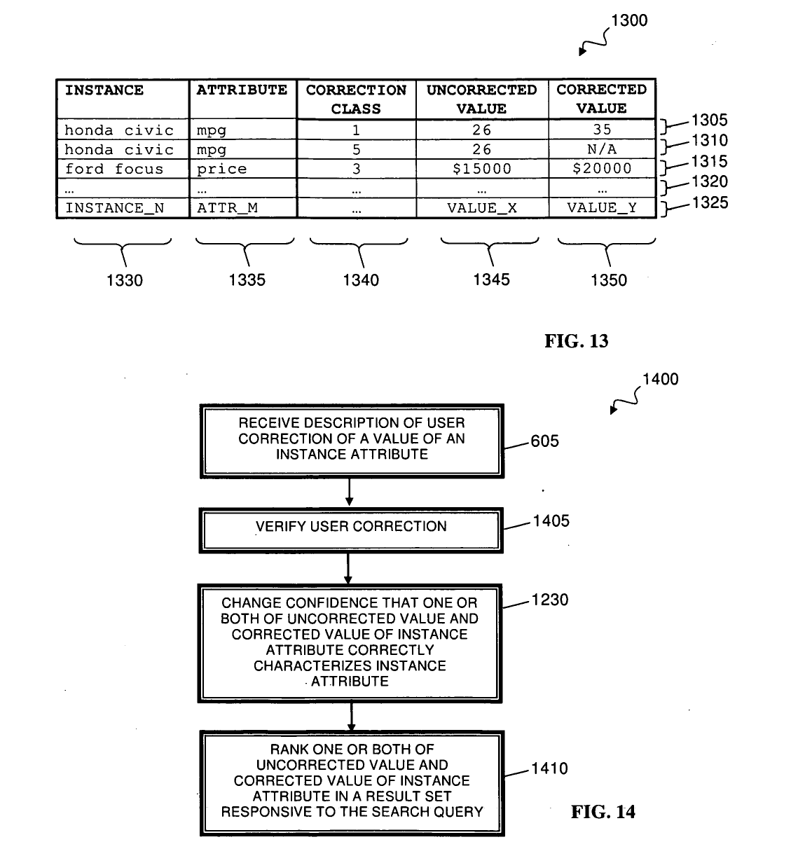

FIG. 13 is a schematic representation of a user correction log, namely, a data table 1300 that includes records 1305, 1310, 1315, 1320, 1325 of user corrections. Data table 1300 is a data structure stored in a digital data storage device for access by a computer program operating on a digital data processing system. Table 1300 includes a collection of columns 1330, 1335, 1340, 1345, 1350. Column 1330 includes instance identifiers that identify the instances in the logged corrections. Column 1335 includes attribute identifiers that identify the attributes of the instances in the logged corrections. Column 1340 includes correction classification identifiers that identify the classifications of the logged corrections. For example, column 1340 can include integers that corresponding to the numbering of the correction classes listed in Table 1. Column 1345 includes uncorrected value identifiers that identify the uncorrected values of the logged corrections. Column 1345 includes corrected value identifiers that identify the corrected values of the logged corrections. In situations where there is no corrected value (e.g., correction class 5: when a user did not change an uncorrected value after direct confirmation from a source), then the respective entry in column 1350 can remain empty or include a dummy value.

As shown in FIG. 12, the system performing process 1200 can repeatedly receive, classify, and log user corrections (steps 605, 1205, 1210). For example, the system can form a database of user corrections, such as historical record of user corrections 110 (FIG. 1).

The system performing process 1200 can receive a search query, the response to which includes an attribute value for an instance (step 1215). For example, the received search query can identify both an instance and an attribute of the instance that is to be characterized in a linguistic pattern or as a consequence of interaction with or reference to a structured presentation.

The system performing process 1200 can access the user correction log (step 1220). For example, the system can read the user correction log from one or more digital data storage devices. The system can also determine whether the contents of a result set responsive to the received search query match a correction of an instance attribute recorded in the user correction log (step 1225). For example, the system can compare the instance and an attribute of the instance that are the subject of the received search query with identifiers of instances and attributes in the user correction log. In the context of a user correction log such as data table 1300 (FIG. 13), the system can first compare the instance that is the subject of the search query with the contents of column 1330 to identify which of user corrections logs 1305, 1310, 1315, 1320, 1325 are relevant to the received search query. The system can then compare the attribute of the instance with the contents of column 1335 in the relevant user corrections logs 1305, 1310, 1315, 1320, 1325.

If the system determines that the received search query does not match a recorded user correction of an instance attribute, the system can return to receive additional descriptions of user corrections at step 605. If the system determines that the received search query matches a recorded user correction of an instance attribute, the system can change the confidence that one or both of the uncorrected value and the corrected value of the instance attribute correctly characterizes the instance attribute (step 1230). The change or changes in confidence can be embodied in one or more confidence parameters, such as scaled ratings or deltas that can be applied to scaled ratings.

FIG. 14 is a flow chart of a process 1400 for improving search with user corrections. Process 1400 can be performed by one or more computers that perform digital data processing operations by executing one or more sets of machine-readable instructions. For example, process 1400 can be performed by the search engine 105 in system 100 (FIG. 1). In some implementations, process 1400 can be performed in response to the receipt of a trigger, such as a user request to use user corrections to improve search. Process 1400 can be performed in isolation or in conjunction with other digital data processing operations. For example, process 1400 can be performed in conjunction with the activities of one or more of processes 600, 700, 1200 (FIGS. 6, 7, 12).

The system performing process 1400 can receive a description of a user correction of a value of an instance attribute (step 605). The system can also verify the user correction (step 1405). In some implementations, the verification can establish the suitability of the format and syntax of a value. For example, capitalization, spelling, and the units (meters, feet, inches, etc.) of a value can be confirmed by corroborating the correction with other sources, e.g., one or more electronic documents available on the Internet. In some implementations, such verifications can be used as a preliminary threshold screening to determine whether subsequent activities—such as changing the confidence that a value correctly characterizes an instance attribute—are to be performed. For example, a user correction of characterization of the “height” attribute of the “Great Pyramid of Giza” instance from a value of “455 feet” to a value of “139 meters” need not result in a change in the confidence of either value. Instead, the system can automatically recognize and confirm unit conversions, e.g., feet to meters, mpg to liters-per-100 km, and so on.

In some implementations, a collection of user corrections are verified and assembled into an aggregated feedback data collection. An aggregated feedback data collection can include information describing attributes of instances, candidate values for those attributes of instances, and description information characterizing a collection of user corrections. Such an aggregation of user corrections can be used to determine the extent to which confidence in candidate values has been increased or decreased by user corrections, as described below.

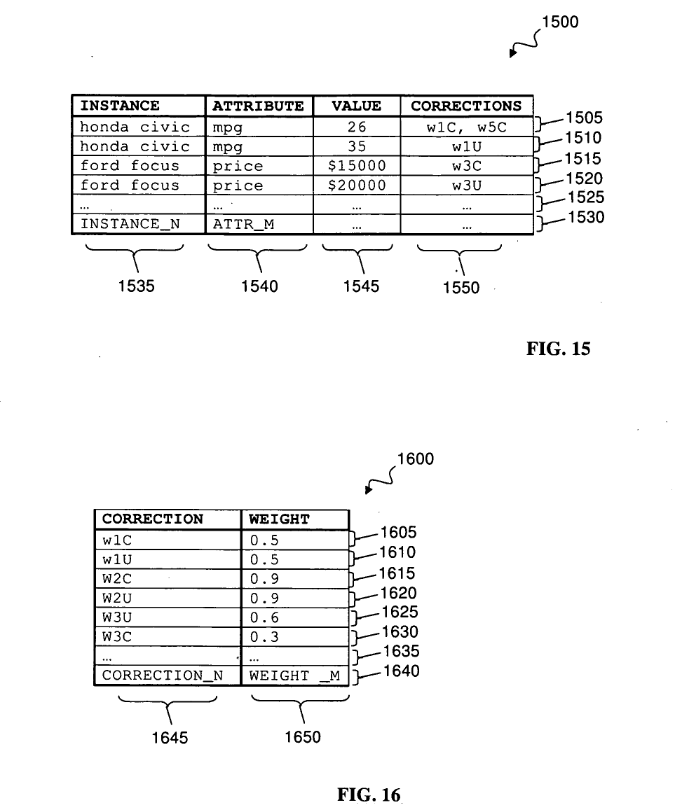

FIG. 15 is a schematic representation of an aggregated feedback data collection, namely, an aggregated feedback data table 1500. Data table 1500 is a data structure stored in a digital data storage device for access by a computer program operating on a digital data processing system. Data table 1500 includes a collection of records 1505, 1510, 1515, 1520, 1525, 1530 that each include description information characterizing one or more user corrections of a value that is potentially suitable for characterizing a particular attribute of a particular instance.

Table 1500 includes a collection of columns 1535, 1540, 1545, 1550. Column 1535 includes instance identifiers that identify the instances for which description information has been aggregated. Column 1540 includes attribute identifiers that identify the attributes of the instances for which signaling information derived from user corrections has been aggregated. Column 1545 includes value identifiers that identify the values for which description information has been aggregated. The values identified in column 1545 potentially characterize the attributes of the instances identified in columns 1535, 1540.

Column 1550 includes an inventory of correction information characterizing categories of user corrections involving the attribute of the instance identified in columns 1535, 1540 and the value identified in column 1545. In the illustrated implementation, the categories characterized in column 1550 are delineated on an individual, correction-by-correction, basis by both the class of the user corrections and whether the value identified in column 1545 was a corrected value or an uncorrected value. In the illustrated implementation, the categories of each individual user correction is categorized using a three unit code of the form “w#B,” where:
“w” is an identifier indicating that a user correction is being categorized;
the number “#” identifies the classification of each individual user correction (here, an integer between one and seven, corresponding to the seven classes described in Table 1); and
the value “B” is a value that identifies whether the value identified in column 1545 was a corrected value or an uncorrected value in the user correction (here, “U” indicating uncorrected and “C” indicating corrected).

In other implementations, user corrections can also be categorized in an aggregated feedback data collection based on information such as the identity of the user making the correction, the date when corrections were made, weighting factors characterizing the correctness of other corrections made by certain users, the context in which corrections were made, and the like.

As shown in FIG. 14, the system performing process 1400 can also change the confidence that one or both of the uncorrected value and the corrected value of the instance attribute correctly characterizes the instance attribute (step 1230). In implementations in which user corrections are individually categorized in an aggregated feedback data collection, confidence can be changed by weighting the individual correction categories. For example, the individual correction categories can be weighted using weighting parameters collected in a weighting parameter data collection.

FIG. 16 is a schematic representation of a weighting parameter data collection, namely, a weighting parameter data table 1600. Data table 1600 is a data structure stored in a digital data storage device for access by a computer program operating on a digital data processing system. Data table 1600 includes a collection of records 1605, 1610, 1615, 1620, 1625, 1630, 1635, 1640 that each include information characterizing the weight of certain categories of user corrections.

Table 1600 includes a collection of columns 1645, 1650. Column 1645 includes correction category identifiers that characterize categories of user corrections. For example, the correction category identifiers can identify categories of user corrections in the same manner that categories of user corrections are characterized in an aggregated feedback data collection, such as in column 1550 of aggregated feedback data able 1500 (FIG. 15).

Column 1650 includes weighting parameters that embody the magnitude of the change in confidence associated with user corrections of the corresponding category. For example, in the illustrated implementation, a weight of 0.9 in records 1615 can indicate that the corrected value selected by a user from a collection after review and direct confirmation from a source (i.e., class 2) has a larger impact on the confidence than when that same value is selected by a user (as the “corrected value”) without review and direct confirmation from a source.

Since the weighting of different categories of user corrections is different, appropriate changes to the confidence that a value correctly characterizes an attribute of an instance can be made. For example, corrections that are made after searches can have a larger impact on confidence than corrections made without searches. As another example, attempts to alter a value by confirming the value directly with a source can have a larger impact on confidence than user deletions of an uncorrected value without direct confirmation from a source.

In other implementations, other characteristics of user corrections can be considered in categorizing and/or weighting user corrections. For example, user corrections made by individuals who have a history of making appropriate corrections can be weighed more heavily that user corrections made by other individuals. As another example, more recent user corrections can be weighed more heavily than older user corrections.

As shown in FIG. 14, the system performing process 1400 can also rank one or both of uncorrected value and corrected value of instance attribute in a result set responsive to the search query (step 1410). In this regard, a value that is more likely to correctly characterize an attribute of an instance is generally ranked above a value that is less likely to correctly characterize an attribute of an instance.

The ranking can reflect the change in confidence that the value correctly characterizes the instance attribute. For example, corrections of different categories can be weighed differently, e.g., using weighting parameters such as shown in weighting parameter data table 1600 (FIG. 16), to generate deltas that are applied to a scaled rating.

For example, in some implementations, a search for an attribute of a value can be conducted in a database or an electronic document collection. The database can include information characterizing, e.g., a collection of structured presentations displayed previously for other users. The search can yield candidate values, each having an individual initial confidence score that embodies the likelihood that the candidate value correctly characterizes the attribute of the instance. Such an initial confidence score can be based on measures such as, e.g., keyword matching, fonts, subdivisions, the precise location of each word, the content of neighboring web pages, and the like. The initial confidence score can be in the form of a scaled rating (e.g., a rating scaled between a lowest possible value (e.g., “0”) and a highest possible value (e.g., a “1”).

Deltas that embody the change in confidence that the value correctly characterizes the instance attribute can then be applied to the initial confidence scores. The application of the deltas to the initial confidence score can yield a changed confidence score that can be used, e.g., to change the content of a result set or re-rank the results in a result set. For example, if inclusion in a result set requires a certain minimum confidence level, the application of deltas to the initial confidence score in a value increase the confidence in that value above the minimum confidence level so that the content of a result set changes. As another example, the application of deltas to the initial confidence score of one value can increase confidence in that value above the confidence score of another value (or decrease confidence in that value below the confidence score of another value). If the results in a result set are ranked, then such changes in the level of confidence can change the ordering of results in the result set. If the results in a result set are constrained to a certain number (e.g., constrained to the four most likely results), then such changes in the level of confidence in results can change the content of the result set.

In some implementations, the application of deltas to initial confidence scores includes multiplying the number of occurrences of each category of user correction by weighting parameters that embody the magnitude (and possibly direction) of the change in confidence associated with that category. The products can then be added to respective initial confidence scores. In some implementations, the magnitude of the weighting parameters, as well as, e.g., the magnitude of a scalar value applied to ensure that the weighting is scaled in accordance with the scale of the initial confidence score, can be determined to maximize the total number of values that are correct after application the confidence scores.

The results in a result set can be ranked based on the sum. The result set with the ranked value or values can be provided to a user, e.g., in a message transmitted over a data transmission network, e.g., message 140 (FIG. 1).

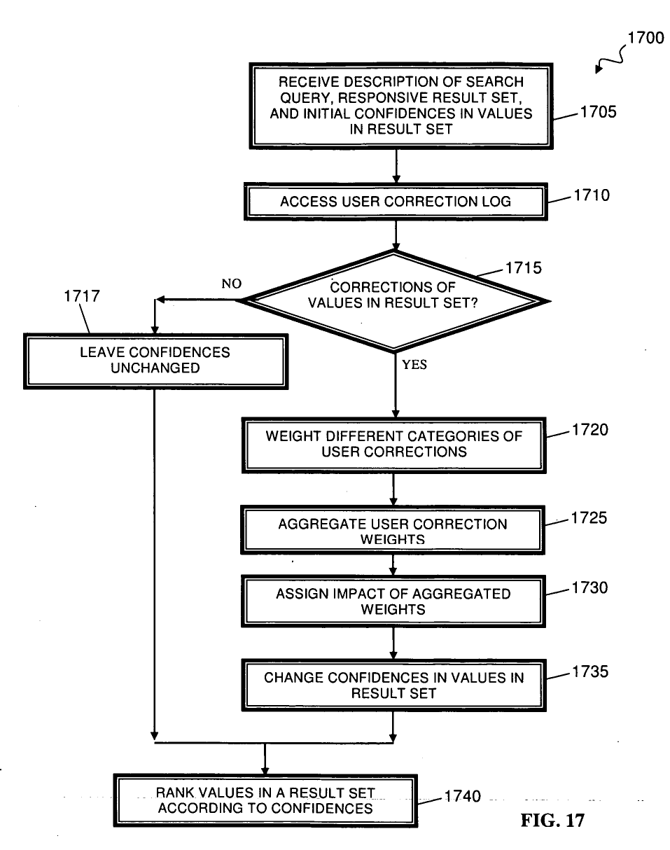

FIG. 17 is a flow chart of a process 1700 for improving search with user corrections. Process 1700 can be performed by one or more computers that perform digital data processing operations by executing one or more sets of machine-readable instructions. For example, process 1700 can be performed by the search engine 105 in system 100 (FIG. 1). In some implementations, process 1700 can be performed in response to the receipt of a trigger, such as a user request to use user corrections to improve search. Process 1700 can be performed in isolation or in conjunction with other digital data processing operations. For example, process 1700 can be performed in conjunction with the activities of one or more of processes 600, 700, 1200, 1400 (FIGS. 6, 7, 12, 14).

The system performing process 1700 can receive a description of a search query (the response to which includes an attribute value for an instance), a result set of candidate values for characterizing the instance attribute, and initial confidences that those values correctly characterize the instance attribute (step 1705). The system can also access a user correction log, such as user correction history 110 (FIG. 1), to search for user corrections of the candidate values in the result set (step 1710).

The system performing process 1700 can also determine whether corrections of the candidate values in the result set are found in the user correction log (step 1715). If the system determines that corrections of the candidate values in the result set are not found, then the system can leave the initial confidences that those values correctly characterize the instance attribute unchanged (step 1717). If the system determines that corrections of the candidate values in the result set are found, then the system can weight the different categories of user corrections (step 1720). For example, in some implementations, the system can weight the different categories of user corrections using the weighting parameters in weighting parameter data table 1600 (FIG. 16).

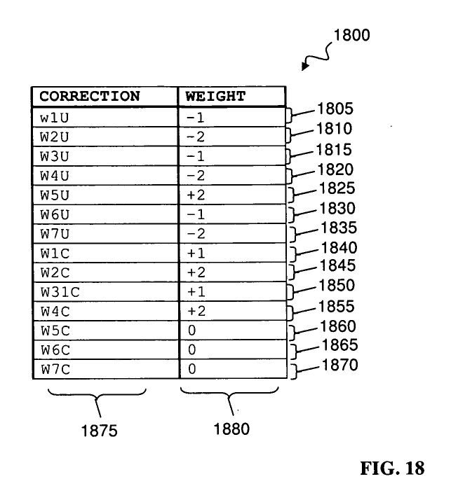

FIG. 18 is a schematic representation of another weighting parameter data table 1800. Data table 1800 is a data structure stored in a digital data storage device for access by a computer program operating on a digital data processing system. Data table 1800 includes a collection of records 1805, 1810, 1815, 1820, 1825, 1830, 1835, 1840, 1845, 1850, 1855, 1860, 1865, 1870 that each include information characterizing the weight of certain categories of user corrections.

Table 1800 includes a collection of columns 1875, 1880. Column 1875 includes correction category identifiers that characterize categories of user corrections. For example, the correction category identifiers can identify categories of user corrections in the same manner that categories of user corrections are characterized in an aggregated feedback data collection, such as in column 1550 of aggregated feedback data able 1500 (FIG. 15).

Column 1880 includes weighting parameters that embody both the magnitude and the direction of the change in confidence associated with user corrections of the corresponding category. For example, in the illustrated implementation, the negative weights in records 1805, 1810, 1815, 1820, 1830, 1835 indicate that the confidence in the values subject to user corrections of the corresponding categories has been decreased. As another example, in the illustrated implementation, the positive weights in records 1825, 1840, 1845, 1850, 1855 indicate that the confidence in the values subject to user corrections of the corresponding categories has been increased. The magnitude of the changes in confidence is indicated by the absolute value of the weights.

As shown in FIG. 17, the system performing process 1700 can aggregate the weights of the corrections of various candidate values (step 1725). In some implementations, the system can sum the weights in order to aggregate them. For example, in the context of the weighting parameters in data table 1800 (FIG. 18), the system can arrive at a sum of “10” when five user corrections of the category W5U have been made. As another example, the system can arrive at a sum of “−10” when five user corrections of the category W4U have been made.

The system performing process 1700 can also assign the impact that the aggregated weights are to have on the confidences in the values in the result set (step 1730). The assigned impact of the aggregated weights need not scale linearly with the magnitude of the aggregation of the weights. For example, in some implementations, the impact of the aggregated weights is a sigmoid function of the magnitude of the aggregation of the weights. For example, the impact of the aggregated weights can be assigned using Equation 1,

$$F ( s ) = \frac{1}{1 + {e}^{( - sk )}} \qquad Equation 1$$

where F(s) is the impact of the aggregated weights “s” and k is a form parameter that helps determine the relationship between the impact of the aggregated weights and the magnitude of the aggregated weights. In implementations where weights such as those in column 1880 of data table 1800 (FIG. 18) are aggregated by summing, k can have a value of approximately two.

The system performing process 1700 can also change the confidence that one or more of the values in the result set correctly characterize the instance attribute (step 1735). For example, the system can multiply the individual confidences received at step 1705 by the respective impacts of the aggregated weights assigned at step 1730. The system can also rank the values in the result set according to their respective confidences (step 1740).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any invention or of what may be claimed, but rather as descriptions of features specific to particular embodiments of the particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. For example, in some implementations, systems such as system 100 include mechanisms for excluding corrections made by non-human users from user correction history 110. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by one or more data processing apparatus, the method comprising:
receiving a value result set at the data processing apparatus, the value result set comprising a collection of one or more values, the values being candidates for characterizing an attribute of an instance;
accessing historical records of user corrections stored at one or more data storage devices, the historical records describing user corrections of the characterization of instance attributes by values;
determining that the historical records of user corrections describe a first user correction involving a first value in the value result set, wherein the first value is involved in the correction as either a corrected value or an uncorrected value; and
changing a confidence parameter embodying a confidence that the first value correctly characterizes the attribute of the instance.

2. The method of claim 1, further comprising:
ranking the values in the value result set according to the changed confidence parameter; and
visually displaying at least a portion of the value result set on a display screen according to the ranking.

3. The method of claim 2, wherein:
visually displaying at least the portion of the value result set comprises presenting a structured presentation to a user;
the structured presentation is populated with a first value included in the value result set; and
the first value has a confidence parameter indicating that the first value is the value in the value result set that is most likely to correctly characterize the instance attribute.

4. The method of claim 2, wherein visually displaying at least a portion of the value result set comprises displaying a candidate window that includes candidate values for characterizing an instance attribute.

5. The method of claim 1, wherein changing the confidence parameter comprises applying a delta value suitable to a scaled confidence rating, the scaled confidence rating embodying the confidence that the involved value correctly characterizes the attribute of the instance.

6. The method of claim 5, wherein generating the delta value comprises weighting a category of a user correction of the involved value.

7. The method of claim 5, wherein generating the delta value comprises categorizing the user correction.

8. A computer storage medium encoded with a computer program, the program comprising instructions that when executed by data processing apparatus cause the data processing apparatus to perform operations, the operations comprising:
receiving a description of a user correction involving a value characterizing an instance attribute, wherein the value is involved in the correction as either a corrected value or an uncorrected value;
changing a confidence parameter reflecting the likelihood that the value correctly characterizes the instance attribute; and
ranking a collection of candidate values that includes the value according to respective confidence parameters, including the changed a confidence parameter.

9. The computer storage medium of claim 8, wherein the operations further comprise transmitting a description of the ranked collection of candidate values over a data communication network in response to receipt of a search query, the response to which includes an attribute value for an instance.

10. The computer storage medium of claim 8, wherein receiving the description of the user correction comprises receiving a description of whether that the user confirmed the correction with a source.

11. The computer storage medium of claim 8, wherein receiving the description of the user correction comprises receiving a description that the user did not change an uncorrected value after reviewing an electronic document.

12. The computer storage medium of claim 8, wherein receiving the description of the user correction comprises receiving a description of the uncorrected value prior to the user correction and the corrected value after the user correction.

13. The computer storage medium of claim 8, wherein changing the confidence parameter comprises:
categorizing the user correction; and
weighting the impact of the user correction on the confidence parameter according to the categorization of the user correction.

14. The computer storage medium of claim 13, wherein weighting the impact of the user correction comprises weighting user corrections made after confirmation from a source more heavily than user corrections made without confirmation from a source.

15. The computer storage medium of claim 13, wherein weighting the impact of the user correction comprises weighting more recent user corrections more heavily than earlier user corrections.

16. The computer storage medium of claim 8, wherein changing the confidence parameter comprises changing the confidence parameter reflecting the likelihood that an corrected value correctly characterizes the instance attribute.

17. A system comprising:
a client device comprising
an input device,
a display screen, and
a digital data processing device operable to display, on the display screen, characterizations of instance attributes by values and to receive, over the input device, user input correcting characterizations of instance attributes;
a correction tracker operable to interact with the client to track the user input correcting the characterizations of the instance attributes and to store descriptions of the user input in records of the user correction history;
one or more data storage devices storing the records of the user correction history; and
a search engine operable to interact with the one or more data storage devices to access the records of the user correction history and to change a confidence that a first value correctly characterizes a first instance attribute in response to identifying a record describing a user correction correcting the characterization of the first instance attribute.

18. The system of claim 17, wherein the display screen displays a structured presentation under the direction of the digital data processing device, the structured presentation associating instance attributes with values.

19. The system of claim 18, wherein the structured presentation comprises interactive elements selectable by a user to identify an instance attribute whose characterization by a value is to be corrected.

20. The system of claim 19, wherein the interactive elements comprise cells of the structured presentation.

21. The system of claim 18, wherein the structured presentation comprises a deck of cards.

22. The system of claim 17, wherein the display screen displays a candidate window under the direction of the digital data processing device, the candidate window presenting candidate corrected values for replacing an uncorrected value characterizing an instance attribute.
